(19) United States
(12) Patent Application Publication
(10) Pub. No.: US 2008/0170384 A1
(43) Pub. Date: Jul. 17, 2008

(54) LAMP

(76) Inventors: Jing (Jim) Zhu, Troy, MI (US); Yue Zhou, Beijing (CN)

Correspondence Address: GIFFORD, KRASS, SPRINKLE,ANDERSON & CITKOWSKI, P.C, PO BOX 7021, TROY, MI, 48007-7021, US

(21) Appl. No.: 11/971,947

(22) Filed: Jan. 10, 2008

Related U.S. Application Data
(60) Provisional application No. 60/884,422, filed on Jan. 11, 2007.

(51) Int. Cl. F21V 7/00; F21V 11/00; F21S 6/00

(52) U.S. Cl. 362/122; 362/307; 362/351; 362/257

(57) ABSTRACT

A lamp which includes a gas inflatable housing which, when inflated, defines an interior pocket. The housing is constructed of a translucent material. A plurality of electrically powered lights are disposed in the pocket and these lights are spaced apart from each other.

### CROSS REFERENCE TO RELATED APPLICATIONS

This application claims priority of United States Provisional Patent Application Ser. No. 60/884,422 filed Jan. 11, 2007, which is incorporated herein by reference.

### BACKGROUND OF THE INVENTION

I. Field of the Invention

The present invention relates generally to lamp assemblies.

II. Description of Relevant Art

There are many different types of lamps which are used in homes, office buildings and the like. These previously known lamps typically utilize incandescent or fluorescent light bulbs as the light source.

Typically, the light bulb is mounted within a socket which, in turn, is supported in a frame of the lamp. A rigid lampshade is typically disposed over the light bulb in order to diffuse the radiation emitted by the light bulb.

These previously known lamps, however, have all suffered from a number of disadvantages. In particular, these previously known lamps employ rigid lampshade as well as rigid frames to support the lampshade and light bulb. The rigid shades and frames, however, are oftentimes bulky in size which increases the shipping cost for the lamps. Furthermore, the lampshade and frame are oftentimes damaged during shipping which requires that the lamp be either repaired or scrapped. In either case, the cost of repairing the damaged lamp or of scrapping the damaged lamp increases the overall manufacturing cost for the lamps. Also, it is more costly and difficult to change the shape, color and design patterns of the previously known lamps.

### SUMMARY OF THE PRESENT INVENTION

The present invention provides a lamp which overcomes the above-mentioned disadvantages of the previously known lamps.

In brief, the lamp of the present invention includes a gas inflatable housing which, when inflated, defines an interior pocket. The housing is constructed of a translucent material, such as vinyl or other plastic material.

A plurality of electrically powered lights are disposed within the housing pocket so that the lights are spaced apart from each other. Preferably, each light comprises a light emitting diode which does not generate heat in operation. As such, unintended damage to the lamp housing from heat is avoided.

In practice, the housing is preferably tubular and cylindrical in shape. Other shapes, however, may also be used without deviation from the spirit or scope of the invention.

### BRIEF DESCRIPTION OF THE DRAWING

A better understanding of the present invention will be had upon reference to the following detailed description when read in conjunction with the accompanying drawing, wherein like reference characters refer to like parts throughout the several views, and in which:

FIG. 1 is an elevational perspective view illustrating a preferred embodiment of the present invention;

FIG. 2 is a view of the lamp of the present invention in a deflated condition; and

FIG. 3 is a sectional view taken substantially along line 3-3 in FIG. 1.

### DETAILED DESCRIPTION OF A PREFERRED EMBODIMENT OF THE PRESENT INVENTION

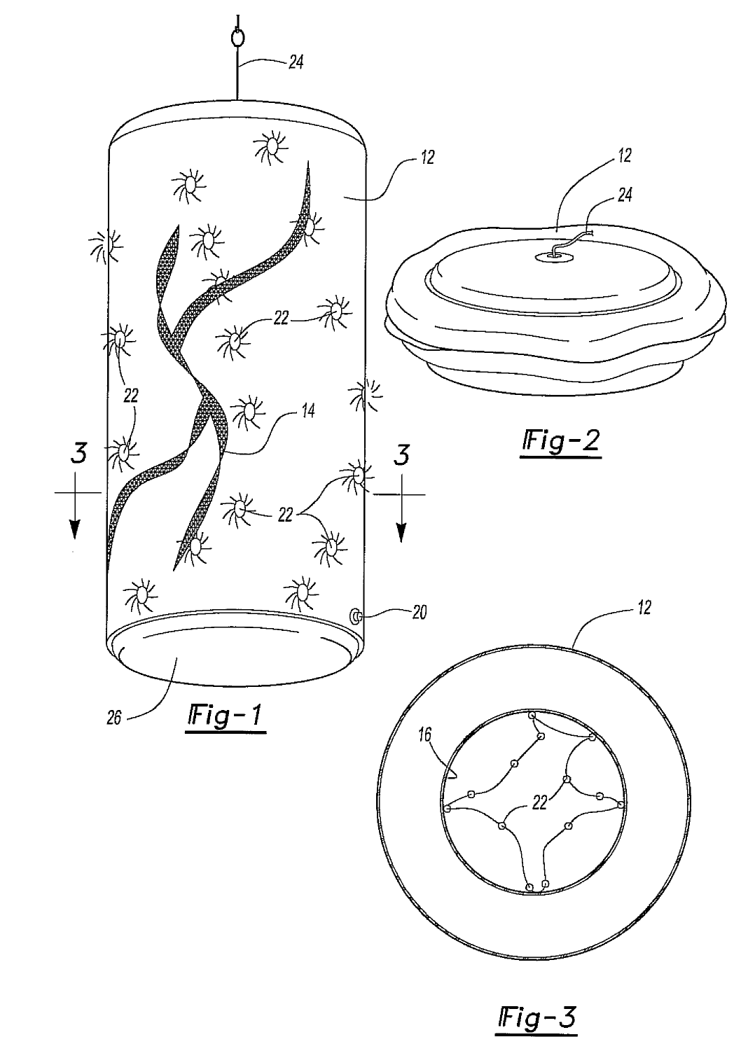

With reference first to FIG. 1, a preferred embodiment of a lamp 10 in accordance with the present invention is illustrated. The lamp 10 includes an elongated tubular cylindrical housing 12.

Referring now to FIGS. 1 and 2, the housing 12 is constructed of a flexible translucent or transparent (hereinafter collectively referred to as “translucent”) material, such as vinyl polymer or other plastic material. The housing 12 may be also color tinted and optionally includes an imprinted design pattern 14 on its outer surface.

With reference now to FIGS. 1 and 2, the housing 12 is air inflatable from a deflated and collapsed condition, illustrated in FIG. 2, to an inflated position as shown in FIG. 1. In its deflated condition shown in FIG. 2, the housing 12 is compact for low cost shipping. Conversely, when the housing 12 is inflated as shown in FIG. 1, the housing 12 is generally tubular and cylindrical in shape and defines an interior pocket 16 (FIG. 3). Any conventional means, such as an air fill port 20, may be utilized to both inflate and deflate the housing 12.

At least one and preferably plurality of lights 22 are disposed within or around the housing pocket 16 so that the lights 22 are spaced apart from each other. These lights 22 are preferably light emitting diodes and may be attached to the housing within the pocket 16 by any conventional means, such as an adhesive, a frictional lock between portions of the housing 12 as illustrated in FIG. 3 as well as any other conventional means. In operation, since the LEDs generate little heat when activated, the entire lamp 10 generates visible light but without the heat of a conventional incandescent bulb.

As shown in FIG. 1, any conventional means, such as a support wire 24, may be used to suspend the housing 12 from a ceiling. Likewise, a stand may also be provided to support the housing 12 above the floor.

As best shown in FIG. 1, a cover 26 optionally extends over and closes one end of the housing 12. Alternatively, a cover 26 may be provided across each end of the housing 12.

In operation, the entire lamp 10 may be inexpensively shipped by deflating the housing 12 to the condition shown in FIG. 2 and then placing the deflated housing 12 together with its associated components into a relatively small slipping container. Following delivery or sale of the lamp 10, the lamp is inflated to the position shown in FIG. 1 and either hung from the ceiling by the support wire 24 or above a floor by a stand. Indeed, the stand is optional since the lamp housing 12 may itself rest on and be supported by a floor.

Upon energization of the lights 22, the lights 22, which are preferably LEDs, generate a pleasant illumination for the lamp 10 without generating heat.

Although the lamp has been illustrated in the drawing as being tubular and cylindrical in shape it will, of course, be understood that the illustrated lamp is for illustration purposes only and in no way limiting of the invention. Other shapes and structures may alternatively be used for the lamp 10.

Having described our invention, however, many modifications thereto will become apparent to those skilled in the art to which it pertains without deviation from the spirit of the invention as defined by the scope of the appended claims.

We claim:

1. A lamp comprising:
a gas inflatable housing, said housing defining an interior pocket, said housing being constructed of a translucent material,
at least one electrically powered light disposed in said pocket.

2. The lamp as defined in claim 1 wherein said housing is constructed of a flexible plastic material, said housing being collapsible when deflated.

3. The lamp as defined in claim 1 wherein said housing is air inflatable.

4. The lamp as defined in claim 1 wherein said housing is tubular and cylindrical when inflated.

5. The lamp as defined in claim 1 wherein said light comprises a light emitting diodes.

6. The lamp as defined in claim 1 wherein said housing is elongated when inflated and includes a closed end.

7. The lamp as defined in claim 1 wherein said lights are spaced apart from each other in said pocket.

8. The lamp as defined in claim 1 wherein said housing material is color tinted.

9. The lamp as defined in claim 1 and comprising a decorative design imprinted on a portion of said housing.

10. The lamp as defined in claim 1 and comprising a decorative plurality of lights disposed in said pocket.
